(19) United States
(12) Patent Application Publication
(10) Pub. No.: US 2024/0026205 A1
(43) Pub. Date: Jan. 25, 2024

(54) DRILLING FLUID, DRILLING METHOD, AND DRILLING FLUID ADDITIVE

(71) Applicants: AKITA UNIVERSITY, Akita-shi (JP); KANEKA CORPORATION, Osaka-shi (JP)

(72) Inventors: Shigemi NAGANAWA, Akita-shi (JP); Ryutaro MUKAI, Settsu-shi (JP)

(73) Assignees: AKITA UNIVERSITY, Akita-shi (JP); KANEKA CORPORATION, Osaka-shi (JP)

(21) Appl. No.: 18/255,424

(22) PCT Filed: Dec. 3, 2021
(86) PCT No.: PCT/JP2021/044520

§ 371 Date: Jun. 1, 2023

(30) Foreign Application Priority Data
Dec. 4, 2020 (JP) 2020-201762

(51) Int. Cl. C09K 8/20; C09K 8/035; C09K 8/03; E21B 21/00

(52) U.S. Cl. CPC C09K 8/206; C09K 8/035; C09K 8/032; E21B 21/003; C09K 2208/08

(57) ABSTRACT

The present invention is directed to a drilling fluid containing water, biodegradable fibers, and a thickener. The thickener contains a water-absorbing silicate, and the biodegradable fibers have a fiber length of 5.0 to 50 mm.

### TECHNICAL FIELD

The present invention relates to a drilling fluid, a drilling method, and a drilling fluid additive.

### BACKGROUND ART

Drilling for purposes such as petroleum extraction is performed using a drilling fluid (also called “drilling mud” or simply called “mud”).

Specifically, the drilling fluid is delivered into a well by a suction tank serving as a pump through a drill string which is a series of pipes including a drill bit (corresponding to a drilling blade) and drill pipes (pipes for transmitting rotational power to the drill bit). The drilling fluid is then returned to the surface of the ground through an annulus (a gap between the drill string and the borehole wall).

Thus, drilling-generated pieces of rock (called “cuttings”) at the well bottom or around the drill bit can be carried to the surface of the ground (cuttings transport and hole cleaning).

The drilling fluid serves also as a lubricant or coolant for the drill bit.

Furthermore, the drilling fluid contributes to control of the pressure inside the well, thereby serving to prevent entry of fluids from the formation into the well or blowout of the fluids to the ground.

The used drilling fluid (the drilling fluid carried to the surface of the ground together with cuttings) is treated, as necessary, by means such as a shale shaker (large-scale sieving device) to remove the cuttings and then recycled. That is, the drilling fluid is circulated between the suction tank and the shale shaker through the drill string and the annulus.

In recycling of the drilling fluid, the components of the drilling fluid may be adjusted (this process is called “mud conditioning”).

In the case where the borehole wall is highly permeable to water (such as when soil particles constituting the formation of the borehole wall are coarse or when there is a crack in the borehole wall), part or all of the drilling fluid delivered into the well could fail to return to the surface of the ground due to permeation of the drilling fluid into the formation (this phenomenon is called “lost circulation”).

The occurrence of lost circulation could cause various problems; for example, the formation softens to make the borehole wall more likely to crumble, or satisfactory drilling becomes infeasible due to shortage of the drilling fluid to be circulated.

A conventional approach to reducing or eliminating the occurrence of lost circulation is to use lost circulation materials. The lost circulation materials are added to the drilling fluid, and the drilling fluid containing the lost circulation materials is passed through the annulus to fill the crack or, in a microscopic level, form a mud cake on the surface of the borehole wall and thus fill gaps between the soil particles. As a result, lost circulation can be prevented.

Examples of currently used lost circulation materials include: fibrous materials such as sugar cane fibers and mineral fibers; granular materials such as limestone, marble, and walnut shell; and flaky materials such as mica flakes and resin film flakes (see Patent Literature 1 or 2, for example).

### CITATION LIST

### Patent Literature

PTL 1: WO 2015/072317
PTL 2: WO 2013/161755

### SUMMARY OF INVENTION

### Technical Problem

A demand for further prevention of lost circulation can arise in the future. However, sufficient investigations have not been made as to further prevention of lost circulation.

It is therefore an object of the present invention to provide a drilling fluid, a drilling method, and a drilling fluid additive that exhibit a good preventive effect on lost circulation.

### Solution to Problem

The present invention relates to a drilling fluid containing water, biodegradable fibers, and a thickener, wherein the thickener contains a water-absorbing silicate, and the biodegradable fibers have a fiber length of 5.0 to 50 mm.

Preferably, the thickener further contains a biodegradable polysaccharide. More preferably, the biodegradable polysaccharide is contained in an amount of 2.0 to 5.0 g/L in the drilling fluid. Even more preferably, the biodegradable polysaccharide includes at least one selected from the group consisting of carboxymethyl cellulose, polyanionic cellulose, xanthan gum, and guar gum.

Preferably, the water-absorbing silicate is contained in an amount of 0.01 to 100 g/L in the drilling fluid.

Preferably, the water-absorbing silicate includes at least one selected from the group consisting of bentonite and sepiolite.

Preferably, the biodegradable fibers include fibers made of a polyhydroxyalkanoate resin. More preferably, the polyhydroxyalkanoate resin contains a 3-hydroxyalkanoate represented by the following formula (1):

[—CHR—CH₂—CO—O—] (1),

wherein R is an alkyl group represented by CₚH₂ₚ₊₁ and p is an integer from 1 to 15.

Even more preferably, the polyhydroxyalkanoate resin includes poly(3-hydroxybutyrate-co-3-hydroxyhexanoate).

Preferably, the content of the biodegradable fibers is from 0.50 to 500 parts by mass per 100 parts by mass of the thickener.

The present invention also relates to a drilling method including drilling a well in conjunction with delivery of a drilling fluid into the well and discharging cuttings generated by the drilling out of the well, wherein the drilling fluid contains water, biodegradable fibers, and a thickener, the thickener contains a water-absorbing silicate, and the biodegradable fibers have a fiber length of 5.0 to 50 mm.

Preferably, the drilling is riser drilling or riserless drilling in an offshore environment.

Preferably, the drilling is riserless drilling in an offshore environment or drilling in an onshore environment.

The present invention further relates to a drilling fluid additive containing biodegradable fibers and a thickener, wherein the thickener contains a water-absorbing silicate, and the biodegradable fibers have a fiber length of 5.0 to 50 mm.

### Advantageous Effects of Invention

The present invention can provide a drilling fluid, a drilling method, and a drilling fluid additive that exhibit a good preventive effect on lost circulation.

### BRIEF DESCRIPTION OF DRAWINGS

FIG. 1 shows the relationship between the concentration of biodegradable fibers and the amount of water loss for drilling fluids of Test Examples (concentration of biodegradable polysaccharide: 4.0 g/L, concentration of water-absorbing silicate (bentonite): 15.0 g/L).

FIG. 2 shows the relationship between the concentration of biodegradable fibers and the thickness of a mud cake for drilling fluids of Test Examples (concentration of biodegradable polysaccharide: 4.0 g/L, concentration of water-absorbing silicate (bentonite): 15.0 g/L).

FIG. 3 shows the relationship between the concentration of biodegradable fibers and the amount of water loss for drilling fluids of Test Examples (concentration of biodegradable polysaccharide: 1.0 g/L, concentration of water-absorbing silicate (bentonite): 15.0 g/L, fiber length of biodegradable fibers: 14.0 mm).

FIG. 4 shows the relationship between the concentration of biodegradable fibers and the thickness of a mud cake for drilling fluids of Test Examples (concentration of biodegradable polysaccharide: 1.0 g/L, concentration of water-absorbing silicate (bentonite): 15.0 g/L, fiber length of biodegradable fibers: 14.0 mm).

FIG. 5 shows the relationship between the concentration of biodegradable fibers and the amount of water loss for drilling fluids of Test Examples (biodegradable polysaccharide: not contained, concentration of water-absorbing silicate (bentonite): 80.0 g/L, fiber length of biodegradable fibers: 14.0 mm).

FIG. 6 shows the relationship between the concentration of biodegradable fibers and the thickness of a mud cake for drilling fluids of Test Examples (biodegradable polysaccharide: not contained, concentration of water-absorbing silicate (bentonite): 80.0 g/L, fiber length of biodegradable fibers: 14.0 mm).

FIG. 7 shows the relationship between the concentration of biodegradable fibers and the amount of water loss for drilling fluids of Test Examples (concentration of biodegradable polysaccharide: 4.0 g/L, concentration of water-absorbing silicate (sepiolite): 15.0 g/L).

FIG. 8 shows the relationship between the concentration of biodegradable fibers and the thickness of a mud cake for drilling fluids of Test Examples (concentration of biodegradable polysaccharide: 4.0 g/L, concentration of water-absorbing silicate (sepiolite): 15.0 g/L).

FIG. 9 shows the relationship between the concentration of biodegradable fibers and the amount of water loss for drilling fluids of Test Examples (concentration of biodegradable polysaccharide: 1.0 g/L, concentration of water-absorbing silicate (sepiolite): 15.0 g/L, fiber length of biodegradable fibers: 14.0 mm).

FIG. 10 shows the relationship between the concentration of biodegradable fibers and the thickness of a mud cake for drilling fluids of Test Examples (concentration of biodegradable polysaccharide: 1.0 g/L, concentration of water-absorbing silicate (sepiolite): 15.0 g/L, fiber length of biodegradable fibers: 14.0 mm).

FIG. 11 shows the relationship between the concentration of biodegradable fibers and the amount of water loss for drilling fluids of Test Examples (biodegradable polysaccharide: not contained, concentration of water-absorbing silicate (sepiolite): 80.0 g/L, fiber length of biodegradable fibers: 14.0 mm).

FIG. 12 shows the relationship between the concentration of biodegradable fibers and the thickness of a mud cake for drilling fluids of Test Examples (biodegradable polysaccharide: not contained, concentration of water-absorbing silicate (sepiolite): 80.0 g/L, fiber length of biodegradable fibers: 14.0 mm).

### DESCRIPTION OF EMBODIMENTS

Hereinafter, one embodiment of the present invention will be described.

[Drilling Fluid]

A drilling fluid according to the present embodiment contains water, biodegradable fibers, and a thickener.

The thickener contains a water-absorbing silicate.

The biodegradable fibers have a fiber length of 5.0 to 50 mm.

(Water)

The water contained in the drilling fluid according to the present embodiment is not limited to a particular type. The water can be water contained in a conventionally known water-based drilling fluid. Examples of the water include fresh water, brine (such as seawater), tap water, groundwater, and any kind of water (such as rainwater) that can enter a well during well drilling performed in any of various environments such as flats, mountains, rivers, canals, and seas.

(Thickener)

The thickener is not limited to a particular type and may be any thickener that contains a water-absorbing silicate and the addition of which increases the viscosity of the drilling fluid.

The thickener may be the water-absorbing silicate itself or may contain a component other than the water-absorbing silicate.

Examples of the component other than the water-absorbing silicate include a biodegradable polysaccharide and an organic colloid (polymer).

The water-absorbing silicate is not limited to a particular type and may be any water-absorbing silicate that functions as a thickener. In other words, the water-absorbing silicate may be any water-absorbing silicate that increases the viscosity of the water when added to the water.

Examples of the water-absorbing silicate include bentonite and sepiolite.

An example of commercially-available bentonite is “TELGEL” manufactured by Telnite Co., Ltd. An example of commercially-available sepiolite is “THERMOGEL” manufactured by Telnite Co., Ltd.

Since in the drilling fluid according to the present embodiment the thickener contains the water-absorbing silicate, a product resulting from water absorption of the water-absorbing silicate can form a mud cake on the surface of the borehole wall. Consequently, permeation of the drilling fluid into the borehole wall and therefore lost circulation can be prevented.

In terms of preventing lost circulation by forming a mud cake on the surface of the borehole wall, the concentration of the water-absorbing silicate in the drilling fluid is preferably 0.01 g/L or more, more preferably 1.0 g/L or more, and even more preferably 10.0 g/L or more.

If the mud cake has an excessively large thickness, this is likely to cause a drilling failure such as jamming (i.e., stopping) of the drill string due to narrowing of the gap between the mud cake and the drill string. For such a reason, the concentration of the water-absorbing silicate in the drilling fluid is preferably 100 g/L or less, more preferably 80 g/L or less, and even more preferably 60 g/L or less.

Preferably, the thickener further contains the biodegradable polysaccharide as a component other than the water-absorbing silicate.

The biodegradable polysaccharide is not limited to a particular type and may be any polysaccharide that has biodegradability and water solubility and the addition of which increases the viscosity of the drilling fluid.

“Biodegradability” in the present embodiment refers to the property of being degradable into low-molecular-weight compounds by microorganisms in nature. Specifically, the possession or lack of biodegradability can be determined based on any of various tests each of which is adapted for a different environment. Examples of tests adapted for aerobic conditions include ISO 14855 (compost) and ISO 14851 (activated sludge), and examples of tests adapted for anaerobic conditions include ISO 14853 (aqueous phase) and ISO 15985 (solid phase). The microbial degradability in seawater can be evaluated by measurement of biochemical oxygen demand.

A “polysaccharide that has water solubility” in the present embodiment refers to a polysaccharide that dissolves in water without retaining its original form or leaving any residue under dissolving conditions (such as dissolving temperature, concentration, and stirring time) suitable for the polysaccharide. Part or all of the polysaccharide only has to dissolve in the drilling fluid at least during drilling operation.

Examples of the biodegradable polysaccharide include: cellulose derivatives such as carboxymethyl cellulose and polyanionic cellulose; glucosamines such as chitosan; xanthan gum; and guar gum. Among these, at least one selected from the group consisting of carboxymethyl cellulose, polyanionic cellulose, xanthan gum, and guar gum is preferred. This is because, for example, guar gum is the best in terms of viscosity and moisture retention under low-temperature conditions, carboxymethyl cellulose has suitable viscosity and is inexpensive, polyanionic cellulose has suitable viscosity and has high salt tolerance, and xanthan gum exhibits high viscosity even when used in a small amount and has shear-thinning property (the property of decreasing the viscosity with increasing shear rate). Any of these polysaccharides may be selected as appropriate depending on the environment of the well to be drilled, the drilling conditions, the availability in the market, and other factors.

The weight-average molecular weight of the biodegradable polysaccharide is preferably 200,000 or more. The weight-average molecular weight may be 1,000,000 or less.

In the drilling fluid according to the present embodiment, the thickener contains the biodegradable polysaccharide in addition to the water-absorbing silicate. Thus, the product resulting from water absorption of the water-absorbing silicate is coated with the biodegradable polysaccharide. This allows the drilling fluid to maintain a stable colloidal state and improves the mud cake forming quality. That is, the mud cake can be stabilized to reduce the amount of the drilling fluid penetrating into the borehole wall (the amount of water loss). As such, permeation of the drilling fluid into the borehole wall can be further prevented.

In terms of coating the product resulting from water absorption of the water-absorbing silicate with the biodegradable polysaccharide and stabilizing the mud cake, the concentration of the biodegradable polysaccharide in the drilling fluid is preferably 2.0 g/L or more.

In terms of preventing excessive viscosity increase of the drilling fluid and ensuring good rheological properties and high drilling efficiency, the concentration of the biodegradable polysaccharide in the drilling fluid is preferably 5.0 g/L or less and more preferably 4.5 g/L or less.

Examples of the organic colloid (polymer) include PHPA (partially hydrolyzed polyacrylamide).

PHPA may include a copolymer of acrylamide and acrylic acid and polyacrylamide.

An example of commercially-available PHPA is “TELCOAT” manufactured by Telnite Co., Ltd.

The concentration of the organic colloid (polymer) in the drilling fluid may be 0.01 g/L or more, 0.5 g/L or more, or 1.0 g/L or more and may be 10.0 g/L or less, 5.0 g/L or less, or 3.0 g/L or less.

(Biodegradable Fibers)

The biodegradable fibers contained in the drilling fluid are fibers having biodegradability.

It is essential that the biodegradable fibers have a fiber length of 5.0 to 50 mm.

A “fiber” has the feature of being thin and long in shape.

The fineness of the biodegradable fibers is expressed in denier (D) or dtex. Denier (D) represents the fiber weight as grams per 9,000 m, and dtex represents the fiber weight as grams per 10,000 m. The fineness of the biodegradable fibers is preferably 1 dtex or more, more preferably 3 dtex or more, and even more preferably 5 dtex or more. The fineness of the biodegradable fibers is preferably 100 dtex or less, more preferably 50 dtex or less, and even more preferably 10 dtex or less.

An exemplary method for measuring the fineness and fiber length of the biodegradable fibers is to randomly select 50 to 100 pieces of the biodegradable fibers, measure the diameters and lengths of the selected biodegradable fibers by DENICON-DC21 (a fineness meter manufactured by Search Co., Ltd.), and calculate the averages of the measured diameters and lengths. Thus, the fineness can be paraphrased as average fiber diameter, and the fiber length can be paraphrased as average fiber length.

The biodegradable fibers contained in the drilling fluid are preferably insoluble in water. The biodegradable fibers need to retain the fibrous form in the drilling fluid at least during drilling operation.

Examples of the biodegradable fibers include fibers derived from biomass such as a microorganism, a plant, or an animal. The biomass-derived fibers include fibers possessed by and extracted from the biomass and fibers obtained by chemical synthesis of a monomer possessed by the biomass.

Examples of the biodegradable fibers include monofilaments or composite fibers containing an aliphatic polyester such as a polyhydroxyalkanoate resin or polylactic acid or containing a polysaccharide such as cellulose. Among these, fibers (including monofilaments or composite fibers) made of a polyhydroxyalkanoate resin are preferred as the biodegradable fibers. This is because the mechanism of biodegradation of polyhydroxyalkanoate resins have been most clearly elucidated and because these resins degrade at a suitable rate in the natural environment and are thus useful as environmentally friendly materials.

The poly(3-hydroxyalkanoate) resin is a polyester whose monomer is a 3-hydroxyalkanoate.

That is, the poly(3-hydroxyalkanoate) resin is a resin containing a 3-hydroxyalkanoate as a structural unit.

The poly(3-hydroxyalkanoate) resin may be a homopolymer or a copolymer.

The polyhydroxyalkanoate resin more preferably contains a 3-hydroxyalkanoate represented by the formula (1) given below as a structural unit. This is because such a polyhydroxyalkanoate resin can have both suitable moldability and high biodegradability.

[—CHR—CH₂—CO—O—] (1)

In the formula (1), R is an alkyl group represented by CₚH₂ₚ₊₁ and p is an integer from 1 to 15.

The poly(3-hydroxyalkanoate) resin preferably includes a poly(3-hydroxybutyrate) resin.

The poly(3-hydroxybutyrate) resin is a resin containing 3-hydroxybutyrate as a structural unit. The poly(3-hydroxybutyrate) resin may be a homopolymer or a copolymer.

Examples of the poly(3-hydroxyalkanoate) resin containing 3-hydroxybutyrate as a structural unit include P3HB, P3HB3HH, P3HB3HV, P3HB4HB, poly(3-hydroxybutyrate-co-3-hydroxyoctanoate), and poly(3-hydroxybutyrate-co-3-hydroxyoctadecanoate).

P3HB refers to poly(3-hydroxybutyrate).

P3HB3HH refers to poly(3-hydroxybutyrate-co-3-hydroxyhexanoate).

P3HB3HV refers to poly(3-hydroxybutyrate-co-3-hydroxyvalerate).

P3HB4HB refers to poly(3-hydroxybutyrate-co-4-hydroxybutyrate).

The poly(3-hydroxyalkanoate) resin preferably includes P3HB because P3HB has the function of accelerating its own crystallization and crystallization of another poly(3-hydroxyalkanoate) resin.

The poly(3-hydroxyalkanoate) resin is preferably P3HB, P3HB3HH, P3HB3HV, or P3HB4HB in terms of improving the moldability of the poly(3-hydroxyalkanoate) resin into the biodegradable fibers while ensuring high biodegradability of the biodegradable fibers.

The poly(3-hydroxyalkanoate) resin preferably contains 85.0 mol % or more of 3-hydroxybutyrate as a structural unit.

When the poly(3-hydroxyalkanoate) resin contains 85.0 mol % or more of 3-hydroxybutyrate as a structural unit, the biodegradable fibers have high stiffness.

The poly(3-hydroxyalkanoate) resin preferably contains 99.5 mol % or less, more preferably 97.0 mol % or less, of 3-hydroxybutyrate as a structural unit.

When the poly(3-hydroxyalkanoate) resin contains 99.5 mol % or less of 3-hydroxybutyrate as a structural unit, the biodegradable fibers are excellent in flexibility.

The biodegradable fibers may contain only one such poly(3-hydroxyalkanoate) resin as described above or two or more such poly(3-hydroxyalkanoate) resins.

In the case where the poly(3-hydroxyalkanoate) resin includes a copolymer (such as P3HB3HH), the poly(3-hydroxyalkanoate) resin may include two or more copolymers differing in the average proportions of structural units.

The weight-average molecular weight of the poly(3-hydroxyalkanoate) resin is preferably from 50,000 to 3,000,000 and more preferably from 50,000 to 1,500,000.

When the weight-average molecular weight of the poly(3-hydroxyalkanoate) resin is 3,000,000 or less, the poly(3-hydroxyalkanoate) resin is easily moldable into the biodegradable fibers.

When the weight-average molecular weight of the poly(3-hydroxyalkanoate) resin is 50,000 or more, the biodegradable fibers can have high strength.

The weight-average molecular weight in the present embodiment refers to that determined from a polystyrene-equivalent molecular weight distribution measured by gel permeation chromatography (GPC) using a chloroform eluent. The column used in the GPC may be any column suitable for measurement of the molecular weight.

Poly(3-hydroxybutyrate-co-3-hydroxyhexanoate) is most preferred as the polyhydroxyalkanoate resin. This is especially because poly(3-hydroxybutyrate-co-3-hydroxyhexanoate) has high biodegradability, has low environmental impact, and is conducive to high performance in cuttings transport and hole cleaning.

The inclusion of fibers made of poly(3-hydroxybutyrate-co-3-hydroxyhexanoate) in the drilling fluid makes it possible to increase the viscosity (and shear stress) of the drilling fluid in a low-shear-rate region while keeping low the viscosity (or maintaining the fluidity) of the drilling fluid in a high-shear-rate region such as the vicinity of the drill bit. This can sufficiently improve the performance in cuttings transport and hole cleaning.

The fibers made of poly(3-hydroxybutyrate-co-3-hydroxyhexanoate) has particularly high biodegradability and thus causes little environmental impact when discarded, dumped, or remaining in the natural environment. Specifically, for example, even when dumped at sea, the fibers made of poly(3-hydroxybutyrate-co-3-hydroxyhexanoate) cause little environmental impact because the fibers have such high degradability in seawater that the fibers disappear in the seawater as a result of being degraded into water and carbon dioxide by microorganisms present in the seawater.

Since the drilling fluid according to the present embodiment contains the biodegradable fibers having a fiber length of 5.0 to 50 mm, permeation of the drilling fluid into the borehole wall can be further prevented.

A possible reason why the fact that the drilling fluid according to the present embodiment contains such biodegradable fibers allows for further prevention of permeation of the drilling fluid into the borehole wall is that the biodegradable fibers having a fiber length within the given range are incorporated into the mud cake to reduce cracks in the mud cake.

The fiber length of the biodegradable fibers is preferably 5.0 mm or more, more preferably 7.0 mm or more, and even more preferably 10.0 mm or more.

The fiber length of the biodegradable fibers is preferably 50 mm or less, more preferably 40 mm or less, and even more preferably 30 mm or less.

In terms of reducing cracks in the mud cake, the drilling fluid according to the present embodiment preferably contains the biodegradable fibers in an amount of 0.50 parts by mass or more, more preferably 2.0 parts by mass or more, even more preferably 5.0 parts by mass or more, per 100 parts by mass of the thickener. The concentration of the biodegradable fibers in the drilling fluid is preferably 0.050 g/L or more and more preferably 0.10 g/L or more.

In terms of allowing the biodegradable fibers to act synergistically with the thickener to effectively prevent lost circulation, the drilling fluid according to the present embodiment preferably contains the biodegradable fibers in an amount of 500 parts by mass or less, more preferably 200 parts by mass or less, per 100 parts by mass of the thickener. The concentration of the biodegradable fibers in the drilling fluid is preferably 10.0 g/L or less and more preferably 5.0 g/L or less.

(Optional Components)

The drilling fluid according to the present embodiment may further contain optional components in addition to the water, the biodegradable fibers, and the thickener as long as the object of the present invention is achieved.

Examples of the optional components include: weighting agents such as barite; dispersants such as lignosulfonic acid derivatives and humic acid; mudstone hydration-swelling inhibitors such as KCl (potassium chloride); water loss control agents; mud cake reinforcing agents; lubricants; surfactants; and pH adjusters such as caustic soda.

[Drilling Fluid Additive]

A drilling fluid additive according to the present embodiment is mixed with water to produce a drilling fluid. That is, the drilling fluid according to the present embodiment can be obtained by mixing the drilling fluid additive according to the present embodiment and water.

The drilling fluid additive according to the present embodiment contains biodegradable fibers and a thickener.

The thickener contains a water-absorbing silicate.

The biodegradable fibers have a fiber length of 5.0 to 50 mm.

The drilling fluid and the drilling fluid additive according to the present embodiment are composed as described above. Hereinafter, a drilling method according to the present embodiment will be described.

[Drilling Method]

The drilling method according to the present embodiment includes drilling a well in conjunction with delivery of a drilling fluid into the well and discharging cuttings generated by the drilling out of the well.

The drilling fluid contains water, biodegradable fibers, and a thickener.

The thickener contains a water-absorbing silicate.

The biodegradable fibers have a fiber length of 5.0 to 50 mm.

The following describes the step of drilling a well in conjunction with delivery of the drilling fluid according to the present embodiment into the well and discharging cuttings generated by the drilling out of the well.

A specific method for drilling a well is, for example, to place a drill string (a series of pipes including a drill bit and drill pipes) into the well and crush or scrape the formation with the drill bit.

A specific method for discharging cuttings generated by the drilling out of the well is, for example, to transport the cuttings together with the drilling fluid to the surface of the ground through an annulus and thereby deliver the cuttings out of the well.

The drilling fluid delivered out of the well and carrying the cuttings may be collected and recycled for drilling. Specifically, the cuttings are removed from the drilling fluid by means of a shale shaker (large-scale sieving device), the components of the drilling fluid are adjusted as necessary, and then the drilling fluid is delivered into the well. In this case, the drilling fluid is circulated between the suction tank serving as a pump and the shale shaker through the drill string and the annulus.

A pipe used in an offshore environment to connect the seabed and a seaborne drilling rig and form an annulus through which a drilling fluid carrying cuttings flows is called a riser pipe. Drilling using the riser pipe is called riser drilling.

The riser drilling has the advantages of: enabling collection of a drilling fluid carrying cuttings in an offshore environment; having a low risk of breaking the well and thus permitting deep drilling; and allowing for easy adjustment of the pressure inside the well. A blowout preventer (BOP) may be mounted at the top of the well, i.e., the wellhead, to prevent ejecta from blowing out of the well due to an increase in the pressure inside the well.

Riserless drilling may be performed in the case where the drilling fluid delivered out of the well and carrying cuttings is not collected. The riserless drilling does not use any riser pipe. In the riserless drilling, the cuttings generated by drilling can be discharged out of the well by delivering the drilling fluid into the well. The cuttings discharged are discarded in the seawater without being collected. The riserless drilling is more suitable for shallow drilling and allows for drilling at more sites in a shorter time than riser drilling.

The drilling may be riser drilling or riserless drilling in an offshore environment or may be drilling in an onshore environment.

The drilling method according to the present embodiment is not limited to being used in a particular environment and may be used in various environments such as flats, mountains, rivers, canals, and seas. The drilling method according to the present embodiment is suitable for use in offshore environments where a reduction in environment impact is particularly required. The drilling method can be used also for geothermal well drilling. The formation in a geothermal area is much hotter than petroleum or natural gas, and the pressure in the formation is low. Thus, the components of the drilling fluid are desirably components resistant to heat.

Being composed as described above, the drilling fluid according to the present embodiment has the following advantages.

That is, the drilling fluid according to the present embodiment contains water, biodegradable fibers, and a thickener. The thickener contains a water-absorbing silicate. The biodegradable fibers have a fiber length of 5.0 to 50 mm.

Since in the drilling fluid according to the present embodiment the thickener contains the water-absorbing silicate, a product resulting from water absorption of the water-absorbing silicate can form a mud cake on the surface of the borehole wall. Consequently, permeation of the drilling fluid into the borehole wall and therefore lost circulation can be prevented.

Since the drilling fluid according to the present embodiment contains the biodegradable fibers having a fiber length of 5.0 to 50 mm, permeation of the drilling fluid into the borehole wall can be further prevented.

A possible reason why the fact that the drilling fluid according to the present embodiment contains such biodegradable fibers allows for further prevention of permeation of the drilling fluid into the borehole wall is that the biodegradable fibers having a fiber length within the given range are incorporated into the mud cake to reduce cracks in the mud cake.

Thus, the present embodiment can provide a drilling fluid, a drilling method, and a drilling fluid additive that exhibit a good preventive effect on lost circulation.

Since the drilling fluid according to the present embodiment contains the biodegradable fibers in addition to the water-absorbing silicate, the drilling fluid can exhibit a better preventive effect on lost circulation with a lower water-absorbing silicate content than drilling fluids that do not contain any biodegradable fibers. The biodegradable fibers are easily degradable in the natural environment, and thus the drilling fluid according to the present embodiment can exhibit a good preventive effect on lost circulation while causing less environmental impact. Additionally, the drilling fluid according to the present embodiment allows for a reduction in the amount of the water-absorbing silicate to be placed in stock at the site of drilling.

Preferably, in the drilling fluid according to the present embodiment, the thickener further contains a biodegradable polysaccharide.

When in the drilling fluid according to the present embodiment the thickener further contains the biodegradable polysaccharide in addition to the water-absorbing silicate, the product resulting from water absorption of the water-absorbing silicate is coated with the biodegradable polysaccharide, and the mud cake is stabilized. Consequently, permeation of the drilling fluid into the borehole wall can be further prevented.

When the drilling fluid according to the present embodiment contains the biodegradable polysaccharide in addition to the water-absorbing silicate and the biodegradable fibers, the drilling fluid can exhibit a better preventive effect on lost circulation with a lower water-absorbing silicate content than drilling fluids that do not contain any biodegradable polysaccharide. The biodegradable polysaccharide is easily degradable in the natural environment, and thus the drilling fluid according to the present embodiment can exhibit a good preventive effect on lost circulation while causing less environmental impact. Additionally, the drilling fluid according to the present embodiment allows for a reduction in the amount of the water-absorbing silicate to be placed in stock at the site of drilling.

The drilling fluid, the drilling method, and the drilling fluid additive according to the present invention are not limited to the embodiment described above. The drilling fluid, the drilling method, and the drilling fluid additive according to the present invention are not limited by the advantageous effects described above. The drilling fluid, the drilling method, and the drilling fluid additive according to the present invention may be modified in various ways without departing from the gist of the present invention.

### EXAMPLES

Hereinafter, the present invention will be described in more detail using Test Examples (Examples and Comparative Examples). The present invention is not limited by these examples in any respect.

### Drilling Fluids of Test Examples 1 to 15, 26, and 27

The following materials were prepared.

That is, fibers made of poly(3-hydroxybutyrate-co-3-hydroxyhexanoate) (P3HB3HH fibers) were cut, and P3HB3HH fibers with different average fiber lengths of 3.0 mm, 5.0 mm, 10.0 mm, and 14.0 mm were prepared as biodegradable fibers.

The P3HB3HH fibers had a fineness of 10.0 dtex, a tensile strength of 1.3 cN/dtex, an elongation of 70.0%, and a Young's modulus of 2.2 GPa.

TELPOLYMER H manufactured by Telnite Co., Ltd. (main component: polyanionic cellulose polymer (PAC) which is a biodegradable polysaccharide) was prepared as a biodegradable polysaccharide-containing material.

TELGEL manufactured by Telnite Co., Ltd. (bentonite from Wyoming in the U.S.) was prepared as a water-absorbing silicate.

Tap water was prepared.

These materials and a household mixer were used to produce drilling fluids of Test Examples 1 to 15, 26, and 27 (Examples and Comparative Examples) where the proportions of the materials were as shown in Table 1 below.

In the tables below and the drawings, “concentration of biodegradable fibers” refers to the concentration of the biodegradable fibers in the drilling fluid, “concentration of biodegradable polysaccharide” refers to the concentration of the biodegradable polysaccharide in the drilling fluid, “concentration of water-absorbing silicate” refers to the concentration of the water-absorbing silicate in the drilling fluid, and “fiber length” refers to the fiber length of the biodegradable fibers.

TABLE 1

| | | | | Test | Test | Test | Test | Test | Test | Test | Test | Test | Test |
|---|---|---|---|---|---|---|---|---|---|---|---|---|---|
| | | | | Ex. 1 | Ex. 2 | Ex. 3 | Ex. 4 | Ex. 5 | Ex. 6 | Ex. 7 | Ex. 8 | Ex. 9 | Ex. 10 |
| | | | | Ex. | Ex. | Ex. | Ex. | Ex. | Ex. | Ex. | Ex. | Comp. | Comp. |
| Material | Biodegradable | Fiber length (mm) | | 5.0 | 5.0 | 10.0 | 10.0 | 14.0 | 14.0 | 14.0 | 14.0 | — | — |
| proportion | fibers | Concentration (g/L) | | 0.5 | 1.0 | 0.5 | 1.0 | 0.5 | 1.0 | 0.5 | 1.0 | | |
| of drilling | | Amount per 100 parts by mass of | | 2.6 | 5.3 | 2.6 | 5.3 | 2.6 | 5.3 | 0.63 | 1.3 | | |
| fluid | | thickener (parts by mass) | | | | | | | | | | | |
| | Thickener | Biodegradable | Concentration | 4.0 | 4.0 | 4.0 | 4.0 | 4.0 | 4.0 | — | — | 4.0 | 1.0 |
| | | polysaccharide | (g/L) | | | | | | | | | | |

| Water-absorbing | Type | Bentonite | | | | | | | | | |
|---|---|---|---|---|---|---|---|---|---|---|---|
| silicate | Concentration | 15.0 | 15.0 | 15.0 | 15.0 | 15.0 | 15.0 | 80.8 | 80.0 | 15.0 | 15.0 |

| | | | Test | Test | Test | Test | Test | Test | Test |
|---|---|---|---|---|---|---|---|---|---|
| | | | Ex. 11 | Ex. 12 | Ex. 13 | Ex. 14 | Ex. 15 | Ex. 26 | Ex. 27 |
| | | | Comp. | Comp. | Ex. | Ex. | Comp. | Ex. | Ex. |
| Material | Biodegradable | Fiber length (mm) | 3.0 | 3.0 | 14.0 | 14.0 | — | 14.0 | 14.0 |
| proportion | fibers | Concentration (g/L) | 0.5 | 1.0 | 0.5 | 1.0 | | 2.5 | 5.0 |
| of drilling | | Amount per 100 parts by mass of | 2.6 | 5.3 | 3.1 | 6.3 | | 3.1 | 6.3 |
| fluid | | thickener (parts by mass) | | | | | | | |

| | | | | | | | | | |
|---|---|---|---|---|---|---|---|---|---|
| Thickener | Biodegradable | Concentration | 4.0 | 4.0 | 1.0 | 1.0 | — | — | — |
| | polysaccharide | (g/L) | | | | | | | |

| Water-absorbing | Type | Bentonite | | | | | | |
|---|---|---|---|---|---|---|---|---|
| silicate | Concentration | 15.0 | 15.0 | 15.0 | 15.0 | 80.0 | 80.0 | 80.0 |

(Evaluation Tests)

An LPLT filter press was used as a filtration tester to filter each of the drilling fluids of Test Examples at a pressure of 7 MPa for 30 minutes (filtration test).

The amount of the fluid passing through the filter (this amount is also referred to as “amount of water loss”), the thickness of the mud cake formed on the filter of the filtration tester, and the solids concentration in the mud cake were determined.

The solids concentration in the mud cake was calculated using the following equation.

Cs=[{WL/(A×FC)}+1]×Ms
Cs: Solids concentration in mud cake (vol %)
WL: Amount of water loss (cm³)
A: Filtration area (cm²)
FC: Thickness of mud cake (cm)
Ms: Solids concentration in drilling fluid (mud) (vol %)

The filtration area was 45.8 cm².

In calculation of the solids concentration in the drilling fluid (mud), the density of bentonite was assumed to be 2.55 g/cm³ in consideration of hydration-induced swelling of bentonite in the drilling fluid (mud).

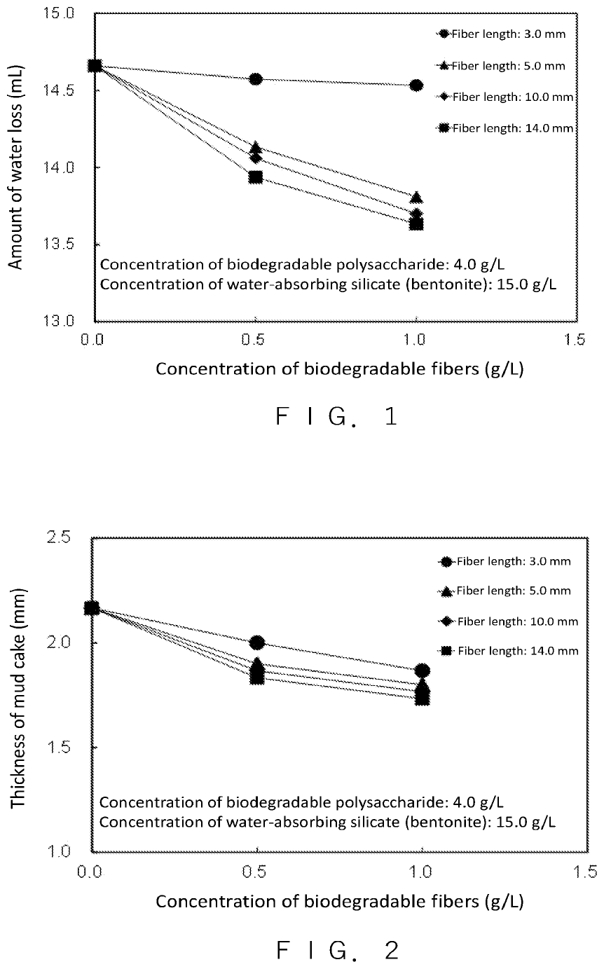

The results are shown in Tables 2 to 5 below and in FIGS. 1 to 6.

The filtration test was conducted three times for each test example. Each of the shown values is an arithmetic mean of the three measured values.

The results shown in Table 2 and FIGS. 1 and 2 are those for test examples where the concentration of the biodegradable polysaccharide in the drilling fluid was 4.0 g/L and the concentration of the water-absorbing silicate (bentonite) in the drilling fluid was 15.0 g/L.

TABLE 2

| | | | Test Ex. | Test Ex. | Test Ex. | Test Ex. | Test Et. |
|---|---|---|---|---|---|---|---|
| | | | 9 | 11 | 12 | 1 | 2 |
| | | | Comp. | | | Ex. | |
| Material | Biodegradable | Fiber length (mm) | — | 3.0 | | 5.0 | |
| proportions of | fibers | Concentration (g/L) | | 0.5 | 1.0 | 0.5 | 1.0 |
| drilling fluid | | Amount per 100 parts by mass of thickener | | 2.6 | 5.3 | 2.6 | 5.3 |
| | | (parts by mass) | | | | | |

| | | | |
|---|---|---|---|
| Thickener | Biodegradable | Concentration (g/L) | 4.0 |

polysaccharide

| Water-absorbing | Type | Bentonite |
|---|---|---|
| silicate | Concentration (g/L) | 15.0 |

| | | | | | | |
|---|---|---|---|---|---|---|
| Results of | Thickness of mud cake (mm) | 2.17 | 2.09 | 1.87 | 1.90 | 1.80 |
| evaluation tests | Solids concentration of mod cake (vol %) | 1.46 | 1.52 | 1.59 | 1.54 | 1.52 |
| | Amount of water loss (ml) | 14.66 | 14.57 | 14.53 | 14.33 | 13.81 |

| | | | Test Ex. | Test Ex. | Test Ex. | Test Ex. |
|---|---|---|---|---|---|---|
| | | | 3 | 4 | 5 | 6 |
| | | | Ex. | | | |
| Material | Biodegradable | Fiber length (mm) | 10.0 | | 14.0 | |
| proportions of | fibers | Concentration (g/L) | 0.5 | 1.0 | 0.5 | 1.0 |
| drilling fluid | | Amount per 100 parts by mass of thickener | 2.6 | 5.3 | 2.6 | 5.3 |
| | | (parts by mass) | | | | |

| | | | |
|---|---|---|---|
| Thickener | Biodegradable | Concentration (g/L) | 4.0 |

polysaccharide

| Water-absorbing | Type | Bentonite |
|---|---|---|
| silicate | Concentration (g/L) | 15.0 |

| | | | | | |
|---|---|---|---|---|---|
| Results of | Thickness of mud cake (mm) | 1.87 | 1.77 | 1.83 | 1.73 |
| evaluation tests | Solids concentration of mod cake (vol %) | 1.55 | 1.68 | 1.57 | 1.60 |
| | Amount of water loss (ml) | 14.06 | 13.70 | 13.94 | 13.63 |

As seen from Table 2 and FIG. 1, the amount of water loss was smaller in Test Examples 1 to 6 (Examples) falling within the scope of the present invention than in Test Example 9 (Comparative Example) where the drilling fluid did not contain any biodegradable fibers and Test Examples 11 and 12 (Comparative Examples) where the fiber length of the biodegradable fibers was as short as 3.0 mm.

This demonstrates that the present invention can prevent lost circulation.

In general, the larger the thickness of the mud cake is, the smaller the amount of water loss is. Thus, the thickness of the mud cake is desirably large in order to prevent lost circulation. However, if the mud cake has an excessively large thickness, this is likely to cause a drilling failure such as jamming (i.e., stopping) of the drill string due to narrowing of the gap between the mud cake and the drill string. Thus, the thickness of the mud cake is desirably small in order to prevent jamming of the drill string.

As seen from Table 2 and FIGS. 1 and 2, the amount of water loss was smaller in Test Examples 1 to 6 (Examples) falling within the scope of the present invention than in Test Example 9 (Comparative Example) where the drilling fluid did not contain any biodegradable fibers and Test Examples 11 and 12 (Comparative Examples) where the fiber length of the biodegradable fibers was as short as 3.0 mm, despite the fact that the thickness of the mud cake was smaller in Test Examples 1 to 6 than in Test Examples 9, 11, and 12.

This demonstrates that the present embodiment can reduce the thickness of the mud cake while preventing lost circulation.

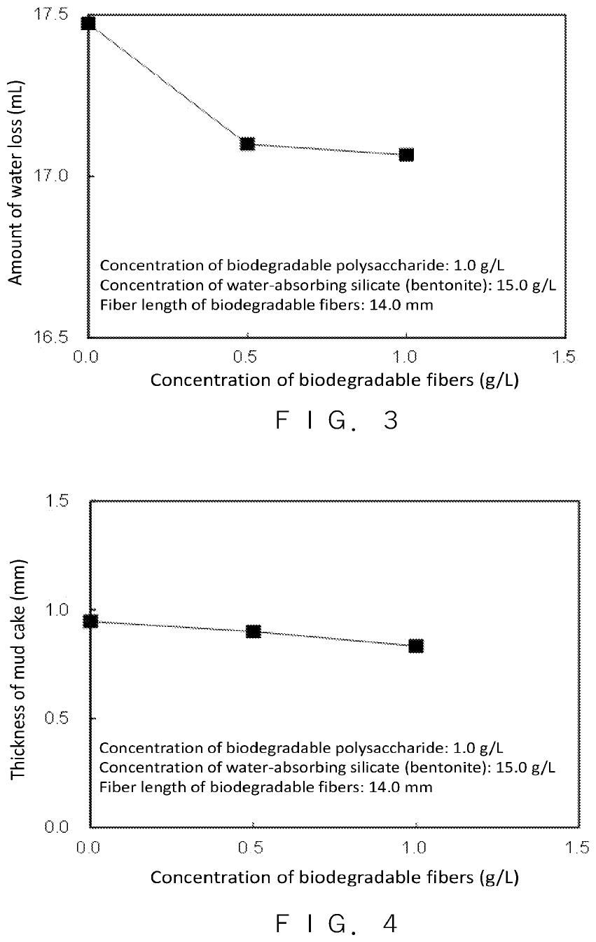

The results shown in Table 3 and FIGS. 3 and 4 are those for test examples where the concentration of the biodegradable polysaccharide in the drilling fluid was 1.0 g/L and the concentration of the water-absorbing silicate (bentonite) in the drilling fluid was 15.0 g/L.

TABLE 3

| | | | Test Ex. | Test Ex. | Test Ex. |
|---|---|---|---|---|---|
| | | | 10 | 13 | 14 |
| | | | Comp. | Ex. | |
| Material | Biodegradable | Fiber length (mm) | — | 14.0 | |
| proportions of | fibers | Concentration (g/L) | | 0.5 | 1.0 |
| drilling fluid | | Amount per 100 parts by mass of thickener | | 3.1 | 6.3 |
| | | (parts by mass) | | | |

| | | | |
|---|---|---|---|
| Thickener | Biodegradable | Concentration (g/L) | 1.0 |

| polysaccharide | | |
|---|---|---|
| Water-absorbing | Type | Bentonite |
| silicate | Concentration (g/L) | 15.0 |

| | | | | |
|---|---|---|---|---|
| Results of | Thickness of mud cake (mm) | 0.95 | 0.90 | 0.83 |
| evaluation tests | Solids concentration in mud cake (vol %) | 2.95 | 3.03 | 3.23 |
| | Amount of water loss (ml) | 17.47 | 17.10 | 17.07 |

As seen from Table 3 and FIG. 3, the amount of water loss was smaller in Test Examples 13 and 14 (Examples) falling within the scope of the present invention than in Test Example 10 (Comparative Example) where the drilling fluid did not contain any biodegradable fibers.

This also demonstrates that the present invention can prevent lost circulation.

As seen from Table 3 and FIGS. 3 and 4, the amount of water loss was smaller in Test Examples 13 and 14 (Examples) falling within the scope of the present invention than in Test Example 10 (Comparative Example) where the drilling fluid did not contain any biodegradable fibers, despite the fact that the thickness of the mud cake was smaller in Test Examples 13 and 14 than in Test Example 10.

This also demonstrates that the present embodiment can reduce the thickness of the mud cake while preventing lost circulation.

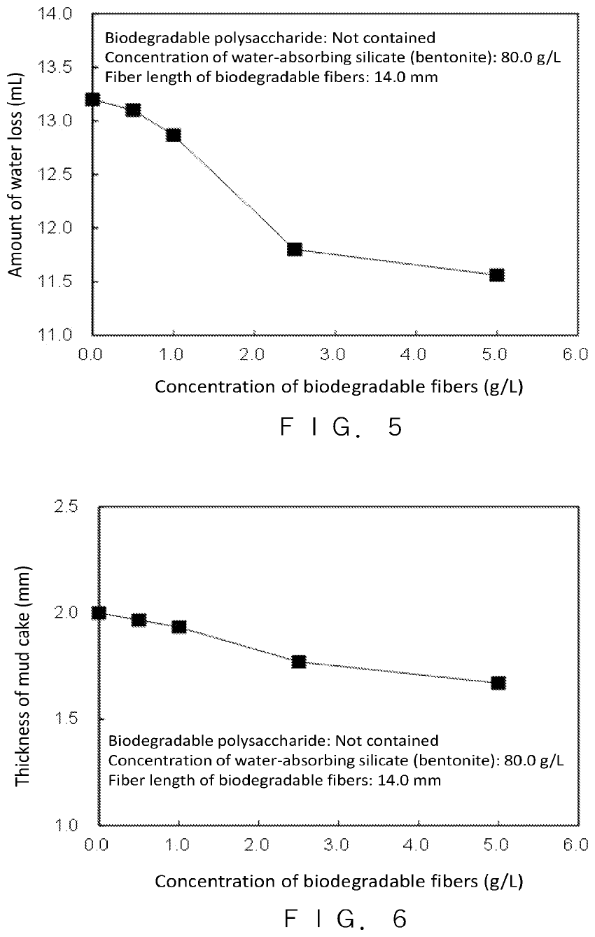

The results shown in Table 4 and FIGS. 5 and 6 are those for test examples where the drilling fluid did not contain any biodegradable polysaccharide and the concentration of the water-absorbing silicate (bentonite) in the drilling fluid was 80.0 g/L.

TABLE 4

| | | | Test Ex. | Test Ex. | Test Ex. | Test Ex. | Test Ex. |
|---|---|---|---|---|---|---|---|
| | | | 15 | 7 | 8 | 26 | 27 |
| | | | Comp. | Ex. | | | |
| Material | Biodegradable | Fiber length (mm) | — | 14.0 | | | |
| proportions of | fibers | Concentration (g/L) | | 0.5 | 1.0 | 2.5 | 5.0 |
| drilling fluid | | Amount per 100 parts by mass of thickener | | 0.63 | 1.3 | 3.1 | 6.3 |
| | | (parts by mass) | | | | | |

| | | | |
|---|---|---|---|
| Thickener | Biodegradable | Concentration (g/L) | — |

polysaccharide

| | | |
|---|---|---|
| Water-absorbing | Type | Bentonite |
| silicate | Concentration (g/L) | 80.0 |

| | | | | | | |
|---|---|---|---|---|---|---|
| Results of | Thickness of mud cake (mm) | 2.00 | 1.97 | 1.93 | 1.77 | 1.67 |
| evaluation tests | Solids concentration in mud cake (vol %) | 7.66 | 7.69 | 7.70 | 7.70 | 7.88 |
| | Amount of water loss (ml) | 13.20 | 13.10 | 12.87 | 11.80 | 11.56 |

As seen from Table 4 and FIG. 5, the amount of water loss was smaller in Test Examples 7, 8, 26, and 27 (Examples) falling within the scope of the present invention than in Test Example 15 (Comparative Example) where the drilling fluid did not contain any biodegradable fibers.

This also demonstrates that the present invention can prevent lost circulation.

As seen from Table 4 and FIGS. 5 and 6, the amount of water loss was smaller in Test Examples 7, 8, 26, and 27 (Examples) falling within the scope of the present invention than in Test Example 15 (Comparative Example) where the drilling fluid did not contain any biodegradable fibers, despite the fact that the thickness of the mud cake was smaller in Test Examples 7, 8, 26, and 27 than in Test Example 15.

This also demonstrates that the present embodiment can reduce the thickness of the mud cake while preventing lost circulation.

The results shown in Table 5 are those for test examples where the fiber length of the biodegradable fibers was 14.0 mm and the concentration of the water-absorbing silicate (bentonite) in the drilling fluid was 15.0 g/L.

TABLE 5

| | | | | Test Ex. | Test Ex. | Test Ex. | Test Ex. |
|---|---|---|---|---|---|---|---|
| | | | | 13 | 5 | 14 | 6 |
| | | | | Ex. | | | |
| Material | Biodegradable | Fiber length (mm) | | 14.0 | | | |
| proportions of | fibers | Concentration (g/L) | | 0.5 | | 1.0 | |
| drilling fluid | | Amount per 100 parts by mass of thickener | | 3.1 | 2.6 | 6.3 | 5.3 |
| | | (parts by mass) | | | | | |
| | Thickener | Biodegradable | Concentration (g/L) | 1.0 | 4.0 | 1.0 | 4.0 |
| | | polysaccharide | | | | | |

| | | |
|---|---|---|
| Water-absorbing | Type | Bentonite |
| silicate | Concentration (g/L) | 15.0 |

| | | | | | |
|---|---|---|---|---|---|
| Results of | Thickness of mud cake (mm) | 0.90 | 1.83 | 0.83 | 1.73 |
| evaluation tests | Solids concentration in mud cake (vol %) | 3.03 | 1.57 | 3.23 | 1.60 |
| | Amount of water loss (ml) | 17.10 | 13.94 | 17.07 | 13.63 |

As seen from Table 5, the thickness of the mud cake was larger and the amount of water loss was smaller in Test Examples 5 and 6 where the concentration of the biodegradable polysaccharide in the drilling fluid was 4.0 g/L than in Test Examples 13 and 14 where the concentration of the biodegradable polysaccharide in the drilling fluid was 1.0 g/L.

This demonstrates that the inclusion of the biodegradable polysaccharide in the drilling fluid can increase the thickness of the mud cake, resulting in a reduction in the amount of water loss.

### Drilling Fluids of Test Examples 16 to 25 and 28 to 32

Drilling fluids of Test Examples 16 to 25 and 28 to 32 (Examples and Comparative Examples) were produced in the same manner as the drilling fluids of Test Examples 1 to 15, 26, and 27, except that THERMOGEL (sepiolite) manufactured by Telnite Co., Ltd. was used as the water-absorbing silicate and that the proportions of the materials were as shown in Table 6 below.

TABLE 6

| | | | | Test Ex. | Test Ex. | Test Ex. | Test Ex. | Test Ex. |
|---|---|---|---|---|---|---|---|---|
| | | | | 16 | 28 | 29 | 30 | 17 |
| | | | | Ex. | Ex. | Ex. | Ex. | Ex. |
| Material | Biodegradable | Fiber length (mm) | | 5.0 | 5.0 | 10.0 | 10.0 | 14.0 |
| proportions of | fibers | Concentration (g/L) | | 0.5 | 1.0 | 0.5 | 1.0 | 0.5 |
| drilling fluid | | Amount per 100 parts by mass of thickener | | 2.6 | 5.3 | 2.6 | 5.3 | 2.6 |
| | | (parts by mass) | | | | | | |
| | Thickener | Biodegradable | Concentration (g/L) | 4.0 | 4.0 | 4.0 | 4.0 | 4.0 |
| | | polysaccharide | | | | | | |
| | | Water-absorbing | Type | Sepiolite | | | | |
| | | silicate | Concentration (g/L) | 15.0 | 15.0 | 15.0 | 15.0 | 15.0 |
| | | | | Test Ex. | Test Ex. | Test Ex. | Test Ex. | Test Ex. |
| | | | | 18 | 19 | 31 | 32 | 20 |
| | | | | Ex. | Comp. | Comp. | Comp. | Ex. |
| Material | Biodegradable | Fiber length (mm) | | 14.0 | — | 3.0 | 3.0 | 14.0 |
| proportions of | fibers | Concentration (g/L) | | 1.0 | | 0.5 | 1.0 | 0.5 |
| drilling fluid | | Amount per 100 parts by mass of thickener | | 5.3 | | 3.1 | 6.3 | 3.1 |
| | | (parts by mass) | | | | | | |
| | Thickener | Biodegradable | Concentration (g/L) | 4.0 | 4.0 | 4.0 | 4.0 | 1.0 |
| | | polysaccharide | | | | | | |
| | | Water-absorbing | Type | Sepiolite | | | | |
| | | silicate | Concentration (g/L) | 15.0 | 15.0 | 15.0 | 15.0 | 15.0 |
| | | | | Test Ex. | Test Ex. | Test Ex. | Test Ex. | Test Ex. |
| | | | | 21 | 22 | 23 | 24 | 25 |
| | | | | Ex. | Comp. | Ex. | Ex. | Comp. |
| Material | Biodegradable | Fiber length (mm) | | 14.0 | — | 14.0 | 14.0 | — |
| proportions of | fibers | Concentration (g/L) | | 1.0 | | 0.5 | 1.0 | |
| drilling fluid | | Amount per 100 parts by mass of thickener | | 6.3 | | 0.63 | 1.3 | |
| | | (parts by mass) | | | | | | |
| | Thickener | Biodegradable | Concentration (g/L) | 1.0 | 1.0 | — | — | — |
| | | polysaccharide | | | | | | |

| Water-absorbing | Type | Sepiolite | | | | |
|---|---|---|---|---|---|---|
| silicate | Concentration (g/L) | 15.0 | 15.0 | 80.0 | 80.0 | 80.0 |

The evaluation tests as described above were conducted for Test Examples 16 to 25 and 28 to 32.

The filtration area was 45.8 cm².

In calculation of the solids concentration in the drilling fluid (mud), the density of sepiolite was assumed to be 2.00 g/cm³ in consideration of hydration-induced swelling of sepiolite in the drilling fluid (mud).

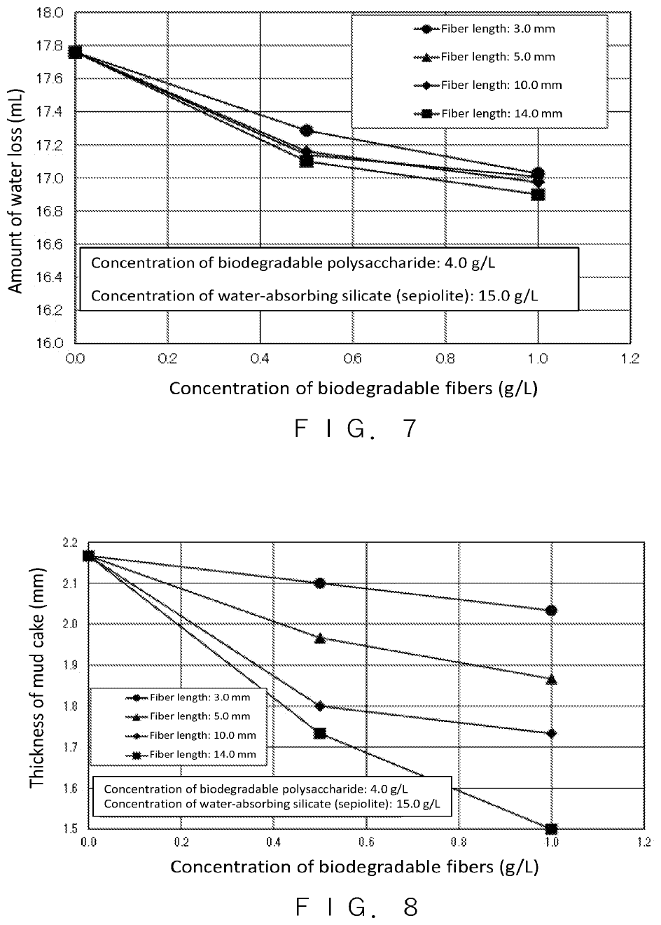

The results are shown in Tables 7 to 10 below and in FIGS. 7 to 12.

The results shown in Table 7 and FIGS. 7 and 8 are those for test examples where the concentration of the biodegradable polysaccharide in the drilling fluid was 4.0 g/L and the concentration of the water-absorbing silicate (sepiolite) in the drilling fluid was 15.0 g/L.

TABLE 7

| | | | Test Ex. | Test Ex. | Test Ex. | Test Ex. | Test Ex. |
|---|---|---|---|---|---|---|---|
| | | | 19 | 31 | 16 | 29 | 37 |
| | | | Comp. | Comp. | Ex. | Ex. | Ex. |
| Material | Biodegradable | Fiber length (mm) | — | 3.0 | 5.0 | 10.0 | 14.0 |
| proportions of | fibers | Concentration (g/L) | | 0.5 | | | |
| drilling fluid | | Amount per 100 parts by mass of thickener | | 3.1 | 2.6 | 2.6 | 2.6 |
| | | (parts by mass) | | | | | |

| | | | |
|---|---|---|---|
| Thickener | Biodegradable | Concentration (g/L) | 4.0 |

polysaccharide

| Water-absorbing | Type | Sepiolite |
|---|---|---|
| silicate | Concentration (g/L) | 15.0 |

| | | | | | | |
|---|---|---|---|---|---|---|
| Results of | Thickness of mud cake (mm) | 2.17 | 2.10 | 1.97 | 1.80 | 1.73 |
| evaluation tests | Solids concentration in mud cake (vol %) | 2.09 | 2.10 | 2.17 | 2.31 | 2.37 |
| | Amount of water loss (ml) | 17.26 | 17.29 | 17.10 | 17.16 | 17.10 |

| | | | Test Ex. | Test Ex. | Test Ex. | Test Ex. |
|---|---|---|---|---|---|---|
| | | | 32 | 28 | 30 | 18 |
| | | | Comp. | Ex. | Ex. | Ex. |
| Material | Biodegradable | Fiber length (mm) | 3.0 | 5.0 | 10.0 | 14.0 |
| proportions of | fibers | Concentration (g/L) | 1.0 | | | |
| drilling fluid | | Amount per 100 parts by mass of thickener | 0.3 | 5.3 | 5.3 | 0.3 |
| | | (parts by mass) | | | | |

| | | | |
|---|---|---|---|
| Thickener | Biodegradable | Concentration (g/L) | 4.0 |

polysaccharide

| Water-absorbing | Type | Sepiolite |
|---|---|---|
| silicate | Concentration (g/L) | |

| | | | | | |
|---|---|---|---|---|---|
| Results of | Thickness of mud cake (mm) | 2.03 | 1.87 | 1.78 | 2.59 |
| evaluation tests | Solids concentration in mud cake (vol %) | 2.12 | 2.24 | 2.36 | 2.59 |
| | Amount of water loss (ml) | 17.08 | 17.01 | 16.97 | 16.90 |

As seen from Table 7 and FIG. 7, the amount of water loss was smaller in Test Examples 16, 29, and 17 (Examples) falling within the scope of the present invention than in Test Example 19 (Comparative Example) where the drilling fluid did not contain any biodegradable fibers and Test Example 31 where the amount of the biodegradable fibers was the same as that in Test Examples 16, 29, and 17 but the fiber length of the biodegradable fibers was 3.0 mm.

As seen from Table 7 and FIG. 7, the amount of water loss was smaller in Test Examples 28, 30, and 18 (Examples) falling within the scope of the present invention than in Test Example 19 (Comparative Example) where the drilling fluid did not contain any biodegradable fibers and Test Example 32 where the amount of the biodegradable fibers was the same as that in Test Examples 28, 30, and 18 but the fiber length of the biodegradable fibers was 3.0 mm.

This demonstrates that the present invention can prevent lost circulation.

As seen from Table 7 and FIGS. 7 and 8, the amount of water loss was smaller in Test Examples 16, 29, and 17 (Examples) falling within the scope of the present invention than in Test Example 19 (Comparative Example) where the drilling fluid did not contain any biodegradable fibers and Test Example 31 where the amount of the biodegradable fibers was the same as that in Test Examples 16, 29, and 17 but the fiber length of the biodegradable fibers was 3.0 mm, despite the fact that the thickness of the mud cake was smaller in Test Examples 16, 29, and 17 than in Test Examples 19 and 31.

As seen from Table 7 and FIGS. 7 and 8, the amount of water loss was smaller in Test Examples 28, 30, and 18 (Examples) falling within the scope of the present invention than in Test Example 19 (Comparative Example) where the drilling fluid did not contain any biodegradable fibers and Test Example 32 where the amount of the biodegradable fibers was the same as that in Test Examples 28, 30, and 18 but the fiber length of the biodegradable fibers was 3.0 mm, despite the fact that the thickness of the mud cake was smaller in Test Examples 28, 30, and 18 than in Test Examples 19 and 32.

This demonstrates that the present embodiment can reduce the thickness of the mud cake while preventing lost circulation.

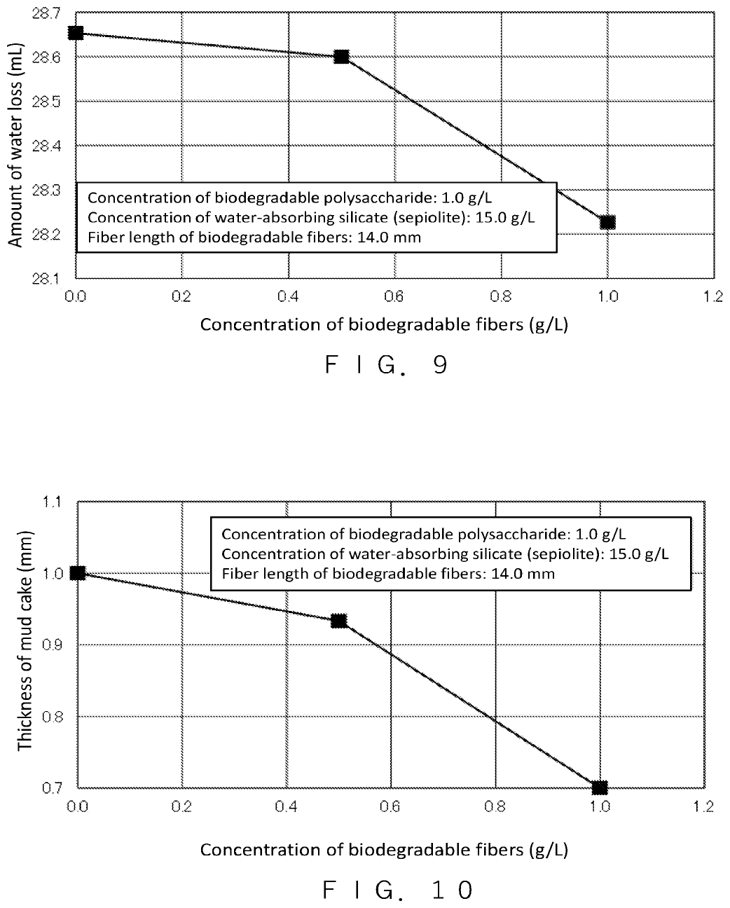

The results shown in Table 8 and FIGS. 9 and 10 are those for test examples where the concentration of the biodegradable polysaccharide in the drilling fluid was 1.0 g/L and the concentration of the water-absorbing silicate (sepiolite) in the drilling fluid was 15.0 g/L.

TABLE 8

| | | | Test Ex. | Test Ex. | Test Ex. |
|---|---|---|---|---|---|
| | | | 22 | 20 | 21 |
| | | | Comp. | Ex. | Ex. |
| Material | Biodegradable | Fiber length (mm) | — | 14.0 | |
| proportions of | fibers | Concentration (g/L) | | 0.5 | 1.0 |
| drilling fluid | | Amount per 100 parts by mass of thickener | | 3.1 | 6.3 |
| | | (parts by mass) | | | |

| | | | |
|---|---|---|---|
| Thickener | Biodegradable | Concentration (g/L) | 10 |

| polysaccharide | | |
|---|---|---|
| Water-absorbing | Type | Sepiolite |
| silicate | Concentration (g/L) | 15.0 |

| | | | | |
|---|---|---|---|---|
| Results of | Thickness of mud cake (mm) | 1.00 | 0.93 | 0.70 |
| evaluation tests | Solids concentration in mud cake (vol %) | 5.44 | 5.79 | 7.35 |
| | Amount of water loss (ml) | 28.65 | 28.60 | 28.23 |

As seen from Table 8 and FIG. 9, the amount of water loss was smaller in Test Examples 20 and 21 (Examples) falling within the scope of the present invention than in Test Example 22 (Comparative Example) where the drilling fluid did not contain any biodegradable fibers.

This also demonstrates that the present invention can prevent lost circulation.

As seen from Table 8 and FIGS. 9 and 10, the amount of water loss was smaller in Test Examples 20 and 21 (Examples) falling within the scope of the present invention than in Test Example 22 (Comparative Example) where the drilling fluid did not contain any biodegradable fibers, despite the fact that the thickness of the mud cake was smaller in Test Examples 20 and 21 than in Test Example 22.

This also demonstrates that the present embodiment can reduce the thickness of the mud cake while preventing lost circulation.

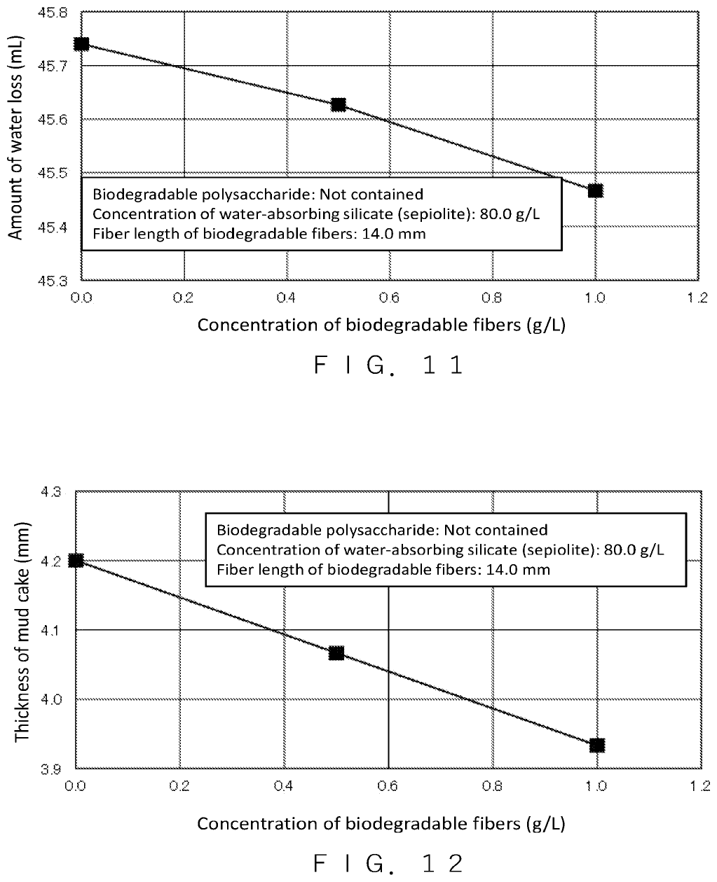

The results shown in Table 9 and FIGS. 11 and 12 are those for test examples where the drilling fluid did not contain any biodegradable polysaccharide and the concentration of the water-absorbing silicate (sepiolite) in the drilling fluid was 80.0 g/L.

TABLE 9

| | | | Test Ex. | Test Ex. | Test Ex. |
|---|---|---|---|---|---|
| | | | 25 | 23 | 24 |
| | | | Comp. | Ex. | Ex. |
| Material | Biodegradable | Fiber length (mm) | — | 14.0 | |
| proportions of | fibers | Concentration (g/L) | | 0.5 | 1.0 |
| drilling fluid | | Amount per 100 parts by mass of thickener | | 0.63 | 1.3 |
| | | (parts by mass) | | | |

| | | | |
|---|---|---|---|
| Thickener | Biodegradable | Concentration (g/L) | — |
| | polysaccharide | | |
| | Water-absorbing | Type | Sepiolite |
| | silicate | Concentration (g/L) | 80.0 |

| | | | | |
|---|---|---|---|---|
| Results of | Thickness of mud cake (mm) | 4.20 | 4.07 | 3,93 |
| evaluation tests | Solids concentration in mud cake (vol %) | 13.51 | 13.79 | 14.55 |
| | Amount of water loss (ml) | 45.74 | 45.63 | 45.47 |

As seen from Table 9 and FIG. 11, the amount of water loss was smaller in Test Examples 23 and 24 (Examples) falling within the scope of the present invention than in Test Example 25 (Comparative Example) where the drilling fluid did not contain any biodegradable fibers.

This also demonstrates that the present invention can prevent lost circulation.

As seen from Table 9 and FIGS. 11 and 12, the amount of water loss was smaller in Test Examples 23 and 24 (Examples) falling within the scope of the present invention than in Test Example 25 (Comparative Example) where the drilling fluid did not contain any biodegradable fibers, despite the fact that the thickness of the mud cake was smaller in Test Examples 23 and 24 than in Test Example 25.

This also demonstrates that the present embodiment can reduce the thickness of the mud cake while preventing lost circulation.

The results shown in Table 10 are those for test examples where the fiber length of the biodegradable fibers was 14.0 mm and the concentration of the water-absorbing silicate (sepiolite) in the drilling fluid was 15.0 g/L.

TABLE 10

| | | | | Test Ex. | Test Ex. | Test Ex. | Test Ex. |
|---|---|---|---|---|---|---|---|
| | | | | 20 | 17 | 21 | 18 |
| | | | | Ex. | Ex. | Ex. | Ex. |
| Material | Biodegradable | Fiber length (mm) | | 14.0 | | | |
| proportions of | fibers | Concentration (g/L) | | 0.5 | | 1.0 | |
| drilling fluid | | Amount per 100 parts by mass of thickener | | 3.1 | 2.6 | 6.3 | 5.3 |
| | | (parts by mass) | | | | | |
| | Thickener | Biodegradable | Concentration (g/L) | 1.0 | 4.0 | 1.0 | 4.0 |
| | | polysaccharide | | | | | |

| | | |
|---|---|---|
| Water-absorbing | Type | Sepiolite |
| silicate | Concentration (g/L) | 15.0 |

| | | | | | |
|---|---|---|---|---|---|
| Results of | Thickness of mud cake (mm) | 0.93 | 1.73 | 0.70 | 1.50 |
| evaluation tests | Solids concentration in mud cake (vol %) | 5.79 | 2.37 | 7.35 | 2.59 |
| | Amount of water loss (ml) | 28.60 | 17.10 | 28.23 | 16.90 |

As seen from Table 10, the thickness of the mud cake was larger and the amount of water loss was smaller in Test Examples 17 and 18 where the concentration of the biodegradable polysaccharide in the drilling fluid was 4.0 g/L than in Test Examples 20 and 21 where the concentration of the biodegradable polysaccharide in the drilling fluid was 1.0 g/L.

This demonstrates that the inclusion of the biodegradable polysaccharide in the drilling fluid can increase the thickness of the mud cake, resulting in a reduction in the amount of water loss.

1. A drilling fluid comprising water, biodegradable fibers, and a thickener, wherein the thickener comprises a water-absorbing silicate, and the biodegradable fibers have a fiber length of 5.0 to 50 mm.

2. The drilling fluid according to claim 1, wherein the thickener further comprises a biodegradable polysaccharide.

3. The drilling fluid according to claim 2, wherein the biodegradable polysaccharide is contained in an amount of 2.0 to 5.0 g/L in the drilling fluid.

4. The drilling fluid according to claim 2, wherein the biodegradable polysaccharide comprises at least one selected from the group consisting of carboxymethyl cellulose, polyanionic cellulose, xanthan gum, and guar gum.

5. The drilling fluid according to claim 1, wherein the water-absorbing silicate is contained in an amount of 0.01 to 100 g/L in the drilling fluid.

6. The drilling fluid according to claim 1, wherein the water-absorbing silicate comprises at least one selected from the group consisting of bentonite and sepiolite.

7. The drilling fluid according to claim 1, wherein the biodegradable fibers comprise fibers made of a polyhydroxyalkanoate resin.

8. The drilling fluid according to claim 7, wherein the polyhydroxyalkanoate resin comprises a 3-hydroxyalkanoate represented by the following formula (1):
[—CHR-CH2-CO—O—] (1),
wherein R is an alkyl group represented by CpH2p+1 and
p is an integer from 1 to 15.

9. The drilling fluid according to claim 7, wherein the polyhydroxyalkanoate resin comprises poly(3-hydroxybutyrate-co-3-hydroxyhexanoate).

10. The drilling fluid according to claim 1, wherein a content of the biodegradable fibers is from 0.50 to 500 parts by mass per 100 parts by mass of the thickener.

11. A drilling method comprising drilling a well in conjunction with delivery of a drilling fluid into the well and discharging cuttings generated by the drilling out of the well, wherein
the drilling fluid comprises water, biodegradable fibers, and a thickener,
the thickener comprises a water-absorbing silicate, and
the biodegradable fibers have a fiber length of 5.0 to 50 mm.

12. The drilling method according to claim 11, wherein the drilling is riser drilling or riserless drilling in an offshore environment.

13. The drilling method according to claim 11, wherein the drilling is riserless drilling in an offshore environment or drilling in an onshore environment.

14. A drilling fluid additive comprising biodegradable fibers and a thickener, wherein
the thickener comprises a water-absorbing silicate, and
the biodegradable fibers have a fiber length of 5.0 to 50 mm.
